(19) United States
(12) Patent Application Publication
(10) Pub. No.: US 2004/0213249 A1
(43) Pub. Date: Oct. 28, 2004

(54) Cell multiplexer for variable speed network interfaces

(76) Inventors: William M. Everett, Livermore, CA (US); Lawrence E. Williams, Benicia, CA (US)

Correspondence Address: SCOTT W HEWETT, 400 WEST THIRD STREET, #223, SANTA ROSA, CA, 95401

(21) Appl. No.: 09/823,339

(22) Filed: Mar. 29, 2001

(51) Int. Cl. H04L 12/28; H04L 12/56

(52) U.S. Cl. 370/395.1

(57) ABSTRACT

A programmable timer is used to meter ATM cells from input buffers to an output buffer in a cell multiplexer of an integrated access device. The timer is programmed according to the egress rate from the cell multiplexer, which is determined by the physical network interface. The programmable timer generates a cell read period that enables an arbiter to read a cell from an input buffer to the output buffer. The cell read period is sufficiently long to avoid overfilling the output buffer or bursting to the network interface. In a particular embodiment a high-priority input and a lower-priority input and the arbiter always checks and reads from the high-priority input before reading from the lower-priority input. In a further embodiment, the high-priority input has an ingress rate that is less than the egress rate.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIS

Not applicable.

### FIELD OF THE INVENTION

The invention relates generally to the transmission of voice and data information on an electronic network and more specifically to metering information packets according to header information associated with the packets to route selected packets for improved delivery across a variety of network connections.

### BACKGROUND OF THE INVENTION

Information networks have been expanding to carry more information, and more diverse types of information, over an increasing variety of carrier media. Telephone lines, for example, were in many cases connected through a series of switches directly from one party to the next, with an audio signal being sent over the line. As demand for telephonic services expanded, several conversations were multiplexed onto a single wire or wire pair, de-multiplexed, and routed to the appropriate party(s). This multiplexing could be done digitally, and was not generally apparent to telephone users. Thus, telephone users have enjoyed and come to expect high-quality, continuous, real-time or near real time conversations over the telephone. In some instances, users may experience short delays over the telephone lines, but conversations are still relatively the same as one might expect face-to-face.

The growth of computer networks, such as the Internet, ushered in different data transmission systems. For example, computers can buffer (store) the data received over a transmission line so a transmission, such as of a text file, sound file, digital picture, or video file, can be sent in pieces to be stored and reassembled into the whole at the receiving computer. A transmission is often split up into packets of data and possibly then into data cells of a fixed size that are then routed over the network. The packets or cells may all take the same route through the network, or may take different routes, or a packet might be segmented into cells that are sent over the same link in the network to be reassembled at a router at the end of the link. In some systems, packet delivery is not guaranteed to occur within any specific time period, but is sent according to a “best efforts” protocol. This may be inconvenient when downloading digital data, but it can profoundly affect real-time information exchange, such as a telephone discussion between two parties.

As the electronic exchange of information has grown, so has the demand (often referred to as “bandwidth”) and the type of transmission media. For example, a transmission network might include pairs of wires, high-frequency co-axial cable, high-frequency radio links, and optical fiber segments. Where only a few years ago relatively low bandwidth voice communication was the primary type of information exchanged over an electronic network, electronic documents, digital image files, and video files have created a rapidly growing demand for more bandwidth and have changed the amount and characteristics of the information carried over the networks.

One approach to handling various types of information, such as voice and data traffic, is to provide each source a separate connection to the physical network. For example, numerous sources of digital data might be combined for transmission over a high-speed network interface that can accommodate re-transmission of data cells, while a different network interface is provided for multiplexed telephone lines. However, this approach requires a user to subscribe to various network interfaces to meet all of his telecommunication needs, which can be relatively costly.

Another approach is to provide a network interface with sufficient capacity to handle different types of traffic, and to appropriately combine the traffic at the user or other node before sending it out over the physical network interface. One approach is to always give top priority to voice traffic data. In other words, if a voice cell is present, it is provided to the network interface; if not, the data input is checked and that data is provided to the network interface. However, if the amount of data from the second input is high, bursting can occur. Bursting is when the data stream from the user exceeds the rate allowed by the carrier (network interface provider). When bursting occurs, the carrier typically truncates the transmission from the user and cells are lost, which can disrupt conversations between the user and another.

Similarly, in some situations the lower-priority input will backfill with idle cells to maintain a desired amount of backpressure, which is used to regulate the data rate from that input. The idle cells are typically stripped and discarded somewhere in the cell multiplexer or interface device, but the process of reading and discarding idle cells can slow down the reading of high-priority cells.

Thus, it is desirable to provide devices and methods that enable real-time transmission of voice information over a transmission network while avoiding bursting and achieving high output bandwidth occupancy. It is further desirable that the devices and methods work with a variety of transmission media and formats.

### SUMMARY OF THE INVENTION

A programmable timer is used as a counter to meter a cell multiplexer in an asynchronous transfer mode (“ATM”)-based integrated access device. The cell multiplexer receives ATM cells from at least two different segmentation and re-assembly units (“SARs”). Cells arriving from one SAR have priority over cells arriving from the other SAR. If a high-priority cell is present at the cell mulitplexer, that cell is transmitted to the physical network before any low-priority cell. The timer is programmed according to the egress capacity of the transmission network to insure that low-priority cell traffic does not interfere with the transmission of high-priority cells. The timer restricts the flow of ATM cells into the output buffer of the cell multiplexer to insure that data is not read into the buffer faster than it can be read out to the physical network interface.

### BRIEF DESCRIPTION OF THE DRAWINGS

FIG. 1 is a simplified diagram of an electronic transmission network with an integrated access device according to an embodiment of the present invention.

FIG. 2 is a simplified flow chart of a process for routing data cells through an integrated access device according to an embodiment of the present invention.

### DETAILED DESCRIPTION OF EMBODIMENTS OF THE INVENTION

1. Introduction

The invention relates to methods and apparatus for routing cells over an electronic transmission network (“network”). For example, asynchronous transfer mode (“ATM”) cells of a fixed size, such as 48 bytes in one embodiment, support a number of different ATM adaptation layers to carry various types of traffic, such as AAL1, AAL2, and AAL5. These cells generally originate from different sources, are terminated at different destinations, and support different levels of quality of service, but are carried through the same network interface. Some AALs, such as AAL1, have a fixed data rate, while others, such as AAL5, can have a variable data rate. Providing a variable data rate can be desirable to more evenly match the ingress rate from the AAL5 source to the egress rate of the cell multliplexer.

Cells from various sources can be combined together on an egress bus and directed towards the network by selecting the cells from the AAL 1 source first, for example, and then the other sources. A counter is used as a timer to meter the flow of data in the egress direction. This counter is programmable to account for the different types of network interfaces, such as T1, E1, DS3, E3, or OC-3c, for example, that the cell multiplexer might support. When the time expires, a high-priority cell, if available, is read into the cell multiplexer, and if a high-priority cell is not available then a lower priority cell will be read. Metering the acceptance of ATM cells avoids over-running the output first-in-first-out (“FIFO”) buffer of the cell multiplexer and dropping high-priority information.

I. Exemplary Cell Multiplexers

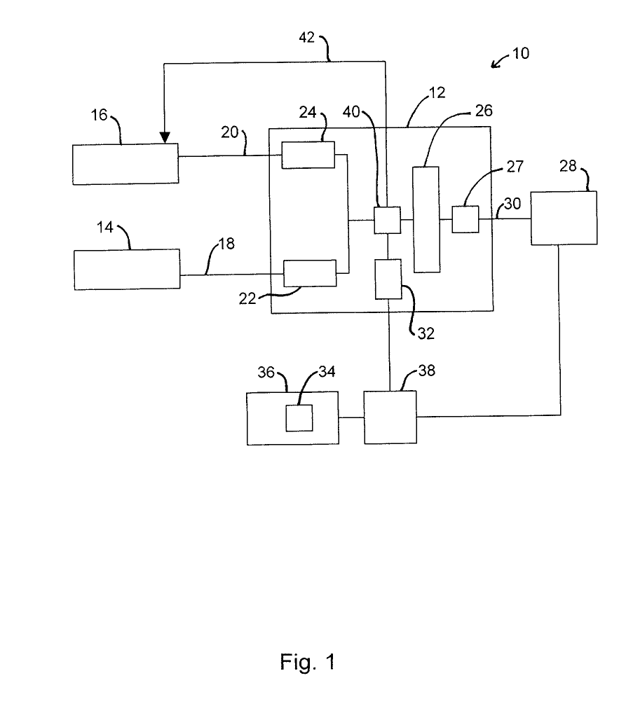

FIG. 1 is a simplified diagram of an integrated access device 10 with a cell multiplexer 12 according to an embodiment of the present invention. The cell multiplexer 12 receives ATM cells from two SARs 14, 16. Typically, one SAR 14 carries traffic that is higher priority than the traffic carried by the other SAR 16. For example, one SAR could provide digitized voice traffic that is important to transmit in real time, while the other SAR carries data traffic that can be partially re-transmitted, if necessary. Thus the integrated access device 10 can combine different types of ATM traffic for transmission over the physical network.

The different SARs typically have different ATM adaptation layers (“AALs”) that provide different ingress rates. For example, the high-priority SAR can be a voice SAR that operates under AAL1 protocol at an ingress rate of about 64 kbps while the data SAR might operate under AAL5 protocol at about the egress data rate, which is about 1.544 Mbps for a T1 line and about 2.048 Mbps for an E1 line. Two inputs (SARs) are shown for simplicity of illustration, additional inputs might be present in other embodiments. Generally speaking, the SARs convert the data into ATM format(s) by organizing the data into cells with associated overhead information.

The SARs are connected to the cell multiplexer 12 over buses 18, 20, such as “UTOPIA” buses, that control the flow of ATM cells between devices. UTOPIA buses are generally self-regulating high-bandwidth buses that enable cell transfer between devices on the bus according to a “handshake” connection and can provide a relatively high data transfer rate. For example, the UTOPIA bus between the AAL5 SAR and its related input buffer 24 might have a maximum data transfer rate of up to 300 Mps, well above the ingress rate of about 1.5 Mbps of the AAL5 SAR when used with a network interface of similar speed.

The cell multiplexer includes a FIFO buffer 22 for the high-priority input and a FIFO buffer 24 for the lower-priority input. Additionally, the cell multiplexer has an output FIFO buffer 26 providing a sequence of cells to the transmit device 27. These buffers store a finite number of cells so that the cells can be queued for transmission through the cell multiplexer to the physical network 28. The cell multiplexer 12 is connected to the physical network 28 via another UTOPIA bus 30, but this type of bus is merely exemplary. The integrated access device is connected to the physical network interface, which is shown in FIG. 1 for purposes of illustration.

The physical network might have any one of a number of interfaces, such as T1, E1, DS3, E3 or OC-3 to name a few. Generally, each interface has a rate at which it can carry information, commonly referred to as “bandwidth”, some interfaces providing higher bandwidth than others. It is generally desirable to match the ingress data flow from all the various sources that might be providing ATM cells to the egress data flow according to the bandwidth of the physical network interface.

If more ATM cells are provided to the physical network interface than it can carry, cells can be lost or discarded. In some instances, those cells can be identified and re-transmitted according to higher-level protocol and control; however, it is generally desirable that high-priority cells, such as real-time person-to-person voice traffic, not be dropped, even if they could be re-transmitted, because it will result in poor voice quality. It is also generally desirable to use (pay for) only the bandwidth that is needed to carry the incoming traffic, but the ingress flow is typically not constant. For example, there may be periods where one SAR or the other is not providing ATM cells to the cell multiplexer.

If the data stream from the output bus 30 of the cell multiplexer 12, exceeds the available bandwidth on the physical network 28, the carrier typically truncates the transmission from the user. The data lost after truncation could be high-priority ATM cells, unless measures are taken to avoid this.

The timer 32 is operated according to a computer-readable program 34 stored in memory 36 that controls a processor 38, which programs the timer according to the egress rate. The processor could be a stand-alone, commercially available microprocessor, or be integrated with other functions of an integrated access device on a application-specific integrated circuit. The processor controls the timer to act like a switch that regulates the egress data stream, or more specifically, the rate of transfer of ATM cells between the input buffers and the output buffer, i.e. the read rate.

The frequency at which the timer operates depends on the allowable output rate. The output rate is set according to the type of network interface line. In this simplified example, if the cell multiplexer receives ATM cells from an AAL1 SAR and an AAL5 SAR, the output rate would generally be about equal to the AAL5 rate, in most situations. The AAL5 SAR will adapt to the egress cell rate (actual data rate) according to feedback provided by the cell metering over the feedback path 42 and may even exceed the actual egress rate, depending on the backpressure, to fully utilize the output path. Generally speaking, the AAL5 SAR will “speed up” to use the available egress bandwidth and “slow down” with increasing back pressure. The metering device provides the correct backpressure to the AAL5 SAR, namely the output metering rate. Alternatively, feedback could be provided from the output buffer or the transmit device. “Backpressure” is used in a general sense to describe the measure of the feedback provided to the SAR, those of ordinary skill in the art understand that it is not a physical pressure, but rather an electronic signal.

The timer is used to keep the AAL5 SAR from overfilling the related input buffer with “fill” (or “idle”) cells, i.e. cells that are generated by the SAR that do not contain data traffic, and which can be discarded without loss of data and are used basically as place-holders. The transmit device typically can also generate fill cells to shape the traffic from the cell multiplexer onto the physical network. In a conventional cell multiplexer, the AAL5 SAR would generate fill cells to shape the traffic from the AAL5 SAR to match the egress traffic. These null cells are typically discarded by the arbiter before being sent to the output buffer; however, their presence in the low-priority input buffer can interfere with reading high priority cells from the high-priority buffer without proper cell metering. The timer insures that the arbiter will check for a high-priority cell in the high-priority input buffer in an efficient and reliable manner.

The processor generates a cell tick period that is basically the inverse of the egress rate of ATM cells rounded down. For example, if 34.9 cells can be sent over the physical network interface within a given time period, the cell transfer rate is rounded down to 34 cells and the inverse is taken to determine the cell tick (cell read) period. This helps to insure that no high-priority cell is dropped by avoiding overflow of the output buffer if the high-speed (lower priority) input bursts data. The processor identifies the type of network interface according to a jumper wire, switch, or similar technique, which is typically set on the integrated access device when it is configured for a system.

There are several opportunities to lose high-priority information. In addition to the carrier truncating a transmission from the user, high-priority ATM cells can be dropped if the high-priority input FIFO buffer 22 or the output FIFO buffer 26 is full when a high-priority cell arrives. Thus it is desirable to make sure the data flow through the cell multiplexer avoids either condition. It is further desirable to place high-priority ATM cells onto the physical network interface as soon as possible, without excessive queuing in the cell multiplexer.

The timer 32 gates an arbiter 40 to read the input FIFO buffers 22, 24. If a high-priority cell is present in the high-priority input FIFO buffer 22, the arbiter passes that cell to the output buffer 26. If no high-priority cell is present in the high-priority input FIFO buffer, then the arbiter 40 checks the lower-priority input FIFO buffer 24 and reads that cell, if present. Cells read from the input buffers are queued in the output buffer 26 for transmission over the physical network.

However, the number of cells the timer allows to be read from either input buffer into the output buffer is limited by the cell tick period. A cell read is enabled for each cell period, and the cell tick rate is set according to the egress rate. Thus, the output buffer will receive cells no faster than it can send them to the physical network, and should maintain buffer space to receive high-priority cells. For example, if the physical network interface can accept 34.9 cells per second from the cell multiplexer, the cell tick period is rounded down to the next integer cell, i.e. to 1/34 second. Of course, a slower rate could be set, if desired. The programmable timer operates as a meter by enabling the arbiter to read a cell from an input buffer each cell tick period, the timer repeating cell tick periods while the circuit is active. In other words, the timer is a continuous timer that enables a cell read each time the cell tick period has lapsed from the previous read enable.

The timer gates the arbiter to read the input buffers at essentially the cell tick period. The arbiter first checks the high-priority input buffer and reads any cells present and then the lower-priority input buffer. The actual read rate might differ slightly from the cell tick rate to account for the time required to operate the arbiter and read the cells. In a relatively low-bandwidth physical network interface, the processing and read time is relatively insignificant compared to the cell tick period, but the significance of this overhead period increases with high-bandwidth egress rates, in which the cell tick period might be very short. In such instances it might be desirable to adjust the read rate to reflect the cell tick period minus the overhead period.

The ingress rate from the high-priority input SAR 14 is less than the egress rate, and in many applications it is much less. Thus the output buffer 26 should have space available to queue cells read from this buffer, and not overfill with cells from the other SAR(s), particularly if those other SARs generate fill cells to try and match the egress rate. Additionally, since the output buffer is filled no faster than cells can be sent to the physical network, bursting is avoided. The differential in speed between the egress rate and the high-priority ingress rate can provide efficient use of the physical network interface, high quality of service for the high-priority ATM cells, and acceptable service for the other ATM cells.

The read rate is typically much faster than the high-priority ingress rate. For example, the egress rate might be 20-200 times greater than the ingress rate from an AAL1 SAR. This allows data to be read from lower-priority SARs even if there is continuous traffic on the high-priority SAR because the cell multiplexer will empty the high-priority input buffer faster than it can be filled, and read cells from the other input buffer(s) in the intervening time. The feedback from the meter to the high-speed SAR(s) also reduces the number of idle cells that SAR might otherwise produce in order to meet a desired ingress rate, such as 1.1 times the maximum bandwidth of the physical network interface.

In other applications, there might be a different ratio between the high-priority ingress and egress rate, depending on the input SAR and physical network interface. In other embodiments, additional high-priority inputs might be present. In such embodiments it is desirable that the sum of the high-priority input ingress rates is less than the egress rate from the cell multiplexer. In one embodiment, inputs having equal priority are read in a round-robin sequence.

While the timer of the embodiment described above meters cells to avoid dropping high-priority cells in a fixed-priority application, the timer could meter cell flow in other environments. For example, rather than always taking a cell from one input if it is present, a weighting function might be provided to dynamically select which input will be read next. The weighting function might be based on how full an input buffer is, or how many cells have been read from a particular input in a given period. Alternatively, other fixed priority applications might be used, such as always alternating between two inputs or reading three or more inputs in a given sequence, such as a rotating sequence. Similarly, the arbiter could be controlled according to a combination of one or more techniques, such as always reading any cell present from a first group of inputs before reading cells from a second group of inputs, and applying various selection rules within the groups.

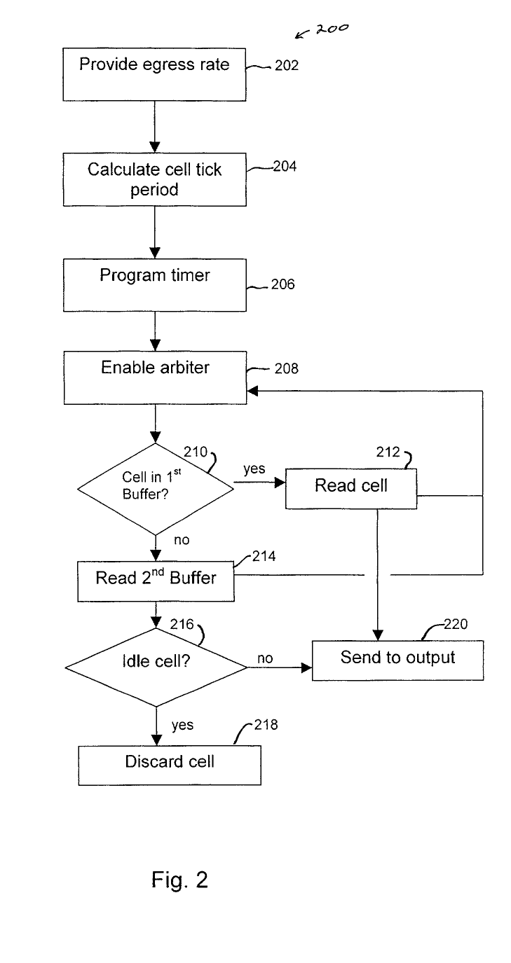

FIG. 2 is a simplified flow chart of a process 200 for routing data cells through an integrated access device according to an embodiment of the present invention. An egress rate of an ATM integrated access device having a high-priority input and a lower-priority input is provided to a processor (step 202), and a cell read period is calculated according to the egress rate (step 204). The processor programs a timer with the cell read period (step 206) and the timer enables an arbiter to read a cell from one of the input buffers each cell read period (step 208).

In a particular embodiment, the arbiter checks (step 210) and reads (step 212) from a first input buffer and sends it to the output 220. If a cell is not present in the first buffer, the arbiter reads a second input buffer (step 214). After reading a cell from one buffer or the other, the process returns to the arbiter and waits until it is enabled again.

In a further embodiment, after reading from the second input buffer, the integrated access device tests the cell from the second input buffer (step 216) and discards that cell if it is a fill cell (step 218). The cells that are read and not discarded are sent to the output buffer (step 220). In a specific embodiment, the egress rate is at least 20 times greater than the ingress rate from the first input.

While the invention has been described above with respect to specific embodiments, substitutions and equivalents might become apparent to those of skill in the art. For example, while the invention has been described with respect to various AALs, other cell transfer techniques could be used. Similarly, specific types of buses and network interfaces have been described, but these are merely exemplary. The invention might be embodied with other buses and interfaces. Accordingly, the invention is defined by the following claims.

What is claimed is:

1. An asynchronous transfer mode (“ATM”) integrated access device comprising:
a first input configured to provide a first plurality of ATM cells at a first ingress rate to
a first input buffer;
a second input configured to provide a second plurality of ATM cells at a second ingress rate to
a second input buffer;
an output buffer configured to queue ATM cells for transmission on a physical network interface at an egress rate;
a programmable timer programmed to generate a cell tick period according to the egress rate;
an arbiter controlled by the programmable timer, the programmable timer enabling the arbiter to read a cell from either the first input buffer or the second input buffer to the output buffer each cell tick period.

2. The ATM integrated access device of claim 1 wherein the egress rate is at least twenty times greater than the first ingress rate.

3. The ATM integrated access device of claim 1 wherein the egress rate is at least two hundred times greater than the first ingress rate.

4. The ATM integrated access device of claim 1 wherein the egress rate is no more than 1.1 times the second ingress rate.

5. The ATM integrated access device of claim 1 wherein the egress rate is at least twenty times greater than the first ingress rate and the egress rate is no more than 1.1 times greater than the second ingress rate.

6. The ATM integrated access device of claim 1 wherein the arbiter is configured to read a first ATM cell in the first input buffer before reading a second ATM cell from the second input buffer.

7. The ATM integrated access device of claim 1 wherein the first plurality of ATM cells are provided by a segmentation and reassembly unit operating according to ATM adaptation layer 1 protocol.

8. An asynchronous transfer mode (“ATM”) integrated access device comprising:
a first input from a first segmentation and reassembly unit operating under ATM adaptation layer 1 protocol, the first input providing a first plurality of ATM cells at a first ingress rate to
a first input buffer;
a second input providing a second plurality of ATM cells to
a second input buffer;
an output buffer configured to queue ATM cells for transmission on a physical network interface at an egress rate, the egress rate being at least twenty times the first ingress rate;
a programmable timer programmed to generate a cell tick period according to the egress rate;
an arbiter enabled by the programmable timer each cell tick period to read a first cell from the first input buffer to the output buffer if the first cell is present in the first input buffer and, if no first cell is present in the first input buffer, to read a second cell from the second input buffer to the output buffer.

9. A method of routing asynchronous transfer mode (“ATM”) cells through an ATM integrated access device, the method comprising:
providing an egress rate of the ATM integrated access device to a processor;
calculating a cell read period according to the egress rate;
programming a programmable timer with the cell read period, the programmable timer
enabling a read of an ATM cell from an input buffer to an output buffer each cell read period.

10. The method of claim 9 wherein the calculating step includes
determining a cell egress rate,
rounding the cell egress rate down to a next lowest integer cell egress rate, and
taking the inverse of the next lowest integer cell egress rate to calculate the cell tick period.

11. The method of claim 10 wherein the determining step determines the cell egress rate according to a physical network interface cell rate.

12. The method of claim 9 wherein the cell read period is a cell tick period minus an overhead period.

13. The method of claim 9 further including steps, after the enabling step, of
checking a high-priority input buffer and, if a high-priority cell is present, reading the high-priority cell to an output buffer, and if a high-priority cell is not present, then
checking a lower-priority input buffer and, if a lower-priority cell is present,
reading the lower-priority cell.

14. The method of claim 13 further comprising steps, after the reading the lower-priority cell step, of
determining if the lower-priority cell is an idle cell, and if the lower priority cell is an idle cell, then
discarding the lower-priority cell.

15. A method of routing asynchronous transfer mode (“ATM”) cells through an ATM integrated access device, the method comprising:
providing an egress rate of the ATM integrated access device to a processor;
determining a cell egress rate;
rounding the cell egress rate down to a next lowest integer cell egress rate;
taking the inverse of the next lowest integer cell egress rate to calculate the cell tick period;
programming a programmable timer with the cell read period; and
enabling an arbiter to read an ATM cell from an input buffer to an output buffer each cell read period.
